(19) United States
(12) Patent Application Publication
(10) Pub. No.: US 2025/0232231 A1
(43) Pub. Date: Jul. 17, 2025

(54) TIME-BOUND LOGICAL LINKAGE BASED SCHEDULING OF RESERVABLE PHYSICAL RESOURCES IN A BUILT PHYSICAL ENVIRONMENT

(71) Applicant: DISH Network Technologies India Private Limited, Bengaluru (IN)

(72) Inventors: Sendhil Kumar KB, Bangalore (IN); Anandaraj P, Bengaluru, Karnataka (IN); Sreevastav Anupuru, Kurnool (IN)

(21) Appl. No.: 18/619,790

(22) Filed: Mar. 28, 2024

(30) Foreign Application Priority Data
Jan. 12, 2024 (IN) 202441002378

(51) Int. Cl. G06Q 10/02; G06Q 10/1093

(52) U.S. Cl. CPC G06Q 10/02; G06Q 10/1093

(57) ABSTRACT

Techniques are described for scheduling reservable physical facilities (RPFs) based on time-bound logical linkages (TBLLs) between wireless location anchors (WLAs) and wireless location finders (WLFs) in a built physical environment (BPE). A reservation event is generated for a selected event RPF of the BPE, identifying an invitee, start time, etc. Based on the reservation event, embodiments identify a WLA as having a respective physical location corresponding to a selected event RPF, a WLF as integrated into a client CE determined to have an association with the event invitee, and an event window based on the event start time. One or more TBLL entries are generated, accordingly, to define a logical linkage between the identified WLA and the identified WLF to be active during the event window. Embodiments can perform several automated features based on the stored TBLL entries during the event window.

### CROSS REFERENCE TO RELATED APPLICATIONS

This application claims priority to Indian Provisional Patent Application No. 202441002378 filed on Jan. 12, 2024, in the Indian Intellectual Property Office, the disclosure of which is incorporated by reference in its entirety for all purposes.

### BACKGROUND

Many day-to-day scenarios arise in which an individual desires, or is expected, to be in a specific place at a specific time. As one category of examples, an employee or guest of an organization may have a meeting scheduled in a particular meeting room, or a student or professor may have a class scheduled in a particular classroom. As another category of examples, a driver may reserve a particular parking space for a particular time, or a hotel guest may be assigned a parking space for the guest's stay. Many calendar applications and other scheduling tools exist for reserving specific locations at specific times. However, such tools tend to be limited in several ways.

One limitation is that such tools conventionally tend to do a poor job of automatically finding most appropriate locations to reserve accounting for characteristics of the reservation (e.g., finding a meeting room that is available at the right time, is the correct size for the number of attendees, has the proper resources to support the meeting, is in a good location for most of the attendees, etc.). Another limitation is that such tools conventionally tend not to provide any integration with any type of automated mapping to assist users with finding the correct location at the correct time. Another limitation is that such tools conventionally tend not to have any automated manner of tracking attendance or whereabouts of invitees. Another limitation is that such tools conventionally tend not to provide any integration with any type of automated access infrastructure, such as facility displays, physical access controls, etc.

### BRIEF SUMMARY

Systems and methods are described herein for scheduling reservable physical facilities (RPFs) based on time-bound logical linkages (TBLLs) between wireless location anchors (WLAs) and wireless location finders (WLFs) in a built physical environment (BPE). A back-end computational environment (CE) can generate a reservation event for a selected event RPF of the BPE (e.g., a meeting room, parking space, etc.), the reservation event identifying at least an event invitee and an event start time. The back-end CE is communicatively coupled with a BPE communication network, and the BPE communication network is further in communication with multiple WLAs, each having a respective physical location in the BPE and a respective logical location in the BPE communication network, wherein each RPF is physically locatable based on the respective physical location of at least one of the WLAs. The back-end CE can determine an identified WLA as one of the WLAs determined to have a respective physical location corresponding to a selected event RPF, an identified WLF as integrated into a client CE determined to have an association with the event invitee, and an event window based on the event start time; and can generate and store one or more TBLL entries for the reservation event that defines a logical linkage between the identified WLA and the identified WLF to be active during the event window. Embodiments can performs several features based on the stored TBLL entries during the event window, such as implementing wireless mapping of the event invitee to the event RPF based on the identified WLF and WLA, event invitee location and attendance tracking, and automated control of physical infrastructure resources (e.g., displays, physical access controls, logical access controls, etc.).

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a built physical environment as a context for embodiments described herein.

FIGS. 2A-2C show different illustrative categories of client computational environment (CE) implementations to support different types of functionality.

FIG. 3 shows an example time-bound logical linkage (TBLL) based reservable physical resource (RPF) scheduling environment.

FIG. 4 shows an illustrative subsequent scene extending the example TBLL-based RPF scheduling environment of FIG. 3.

FIG. 5 shows an illustrative scene corresponding to an example parking lot use cases.

FIGS. 6 and 7 show illustrative computational systems for implementing embodiments of a back-end CE or a client CE, respectively, according to embodiments described herein.

FIG. 8 shows a flow diagram of a method for scheduling RPFs based on TBLLs between wireless location anchors (WLAs) and wireless location finders (WLFs) in a built physical environment (BPE), according to embodiments described herein.

### DETAILED DESCRIPTION

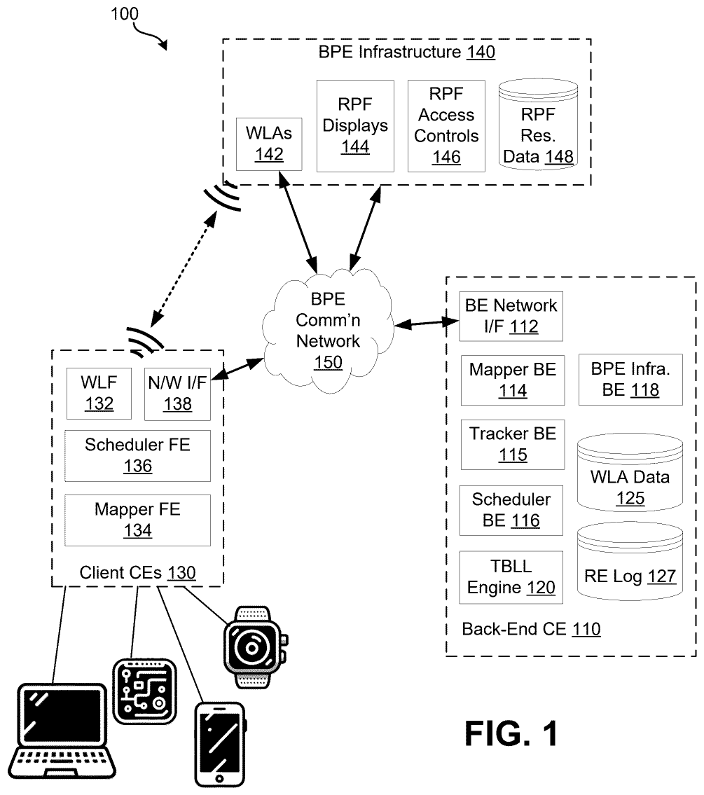

Turning first to FIG. 1, a built physical environment 100 is shown as a context for embodiments described herein. The illustrated built physical environment (BPE) 100 includes a BPE infrastructure 140, a BPE communication (comm'n) network 150, a back-end (BE) computational environment (CE) 110, and one or more client CEs 130. Embodiments described herein operate in the context of a reservable physical facility (RPF) of the BPE 100 being reserved by and/or for one or more individuals for some timeframe. Each such individual is referred to herein as an “invitee,” regardless of whether a second-party (“inviter”) reserved the RPF on behalf of the individual (i.e., the individual was invited), or the individual reserved the RPF for themself (i.e., the individual is both the inviter and the invitee); and also regardless of whether there is a single invitee associated with the reservation of the RPF in that timeframe, or multiple invitees associated with the reservation of the RPF in that timeframe.

As used herein, the term BPE 100 generally includes any commercial and/or non-commercial, indoor and/or outdoor built environment having, within a defined physical area, multiple reservable physical facilities (RPFs). The RPFs are not explicitly shown in FIG. 1. As used herein, the term RPF generally includes any reservable, individual, functional area designed for specific uses or activities. As one example, a hospital (BPE) can include a number of operating rooms and conference rooms (RPFs). As another example, a university campus (BPE) can include a number of lecture halls, auditoriums, and meeting spaces (RPFs). As another example, an office building (BPE) can include a number of meeting rooms, conference areas, and presentation halls (RPFs). As another example, a shopping mall (BPE) can include a number of event spaces and pop-up shop locations (RPFs). As another example, a sports complex (BPE) can include a number of playing fields, courts, and private gym spaces (RPFs). As another example, a residential apartment complex (BPE) can include a number of event rooms, communal kitchens, and rooftop terraces (RPFs). As another example, an airport (BPE) can include a number of VIP lounges and conference rooms (RPFs). As another example, a museum (BPE) can include a number of exhibition halls, event spaces, and auditoriums (RPFs). As another example, a public park (BPE) can include a number of picnic areas, pavilions, and event lawns (RPFs). As another example, a convention center (BPE) can include a number of exhibition spaces, meeting rooms, and banquet halls (RPFs). As another example, a hotel (BPE) can include a number of guest rooms, banquet halls, and conference rooms (RPFs). As another example, a parking garage (BPE) can include a number of parking spaces and valet service areas (RPFs). As another example, a transit station or luggage storage facility (BPE) can include a number of luggage storage lockers (RPFs).

According to embodiments described herein, each RPF has both a corresponding physical location within the BPE infrastructure 140 and a corresponding logical location defined within the BPE communication network 150. Embodiments of the BPE communication network 150 can include any suitable communications network(s), infrastructure(s), architecture(s), etc. suitable for providing coverage over some or all of the RPFs in the BPE infrastructure 140 to support features described herein. In some implementations, the BPE communication network 150 includes a wide area network (WAN) of distributed wireless fidelity (WiFi) networking components (e.g., WiFi hubs, routers, etc.). In some implementations, the BPE communication network 150 includes an ultra-wideband (UWB) network of distributed devices with UWB transceivers. In some implementations, the BPE communication network 150 includes any suitable public and/or private, wired and/or wireless communication networks and links, such as Ethernet networking links and/or components, radiofrequency networking links and/or components, cellular networking links and/or components, optical networking links and/or components, narrow-band Internet of Things (NB-IoT) networking links and/or components, etc. The various networking links and/or components can form one or more WANs, local area networks (LANs), personal area networks (PANs), mesh networks, ad-hoc networks, specialized networks (e.g., a digital signage network), etc.

As illustrated, the BPE communication network 150 is in communication with elements of the BPE infrastructure 140, with the back-end CE 110, and with any client CE(s) 130 that are presently in communication therewith (e.g., in wireless range of the BPE communication network 150 and logged on to the BPE communication network 150). As described herein, embodiments of the back-end CE 110 generate and manage time-bound logical linkages (TBLLs) between wireless location anchors (WLAs) 142 and wireless location finders (WLFs) 132 in accordance with reservations of RPFs across the BPE infrastructure 140. For example, each RPF corresponds to one or more WLAs 142, each WLF 132 corresponds to a device of an invitee (at least temporarily), and the TBLL logically links the RPF and the WLF 132 for a particular time period based on a reservation of the RPF for and/or by the invitee. Embodiments provide additional features in association with generating and/or handling the TBLL. For example, embodiments of the back-end CE 110 can provide dynamic RPF reservation based on matching RPF resource data 148 with reservation features, automated wireless mapping of WLFs 132 to RPFs (using WLAs 142) based on TBLLs, automated coordination of RPF displays 144 with TBLLs, automated coordination of RPF access controls 146 with TBLLs, automated attendee tracking based on TBLLs, etc.

As used herein, the term “WLA” refers to a transceiver anchored to a particular location in the BPE infrastructure 140, and the term “WLF” refers to a transceiver in a mobile format (e.g., integrated with a smartphone, a laptop, a smartwatch, an IoT device, a smart badge, a vehicle, etc.) that moves with an invitee. In some cases, a WLA 142 is implemented as a single physical transceiver in a single location, such that the physical and logical locations of that transceiver are the physical and local locations of the WLA 142. In other cases, a WLA 142 is jointly implemented by multiple physical receivers and/or transmitters in multiple physical locations, such that the WLA 142 forms as a “virtual WLA” in a particular location based on a combination of signals from the multiple physical transceivers (e.g., based on beamforming, triangulation, time of flight, angle of attack, etc.). Each such WLA 142 (i.e., each virtual WLA) can be assigned a corresponding physical and logical identifier.

In connection with generating and handling TBLLs, the back-end CE 110 can recognize each RPF in relation to a WLA 142 and can recognize each invitee in connection with a WLF 132. When a TBLL is established between a WLA 142 and a WLF 132, the WLA 142 and the WLF 132 communicate with each other. In some implementations, the communication is via the BPE communication network 150. In some such implementations, the WLAs 142 and WLFs 132 communicate using the same (or compatible) communication protocols, such as WiFi (e.g., 802.11) protocols, or the like. In other such implementations, the WLAs 142 and WLFs 132 may not use communication protocols that are the same, or even compatible, so long as all can communication with the BPE communication network 150. In other implementations, the WLAs 142 and WLFs 132 communicate with each other directly, or via a separate network (i.e., not via the BPE communication network 150). For example, the WLAs 142 and WLFs 132 both include UWB transceivers.

As noted above, the back-end CE 110 can recognize each RPF in relation to a WLA 142. Just as RPFs are physically distributed across some or all regions of the BPE, WLAs 142 are physical distributed across some or all regions of the BPE 100 at a quantity and density needed for the back-end CE 110 to use the WLAs 142 for locating the RPFs. As described above, in some implementations, each WLA 142 is implemented by a single physical transceiver. The transceiver is collocated with a particular RPF, and the physical and logical locations of the RPF have a one-to-one correspondence with the physical and logical locations of the collocated WLA 142. For example, a WLA 142 is implemented as a UWB tag or anchor, which is physically located in a meeting room, in a parking spot, etc. In other implementations, the WLA 142 is a virtual WLA formed by multiple receivers and/or transmitters. Such implementations still consider the virtual WLA as a single WLA 142 associated with the RPF; although there may not be a physical WLA transceiver collocated with the RPF, the physical and logical locations of the RPF can still have a one-to-one correspondence with those of the virtual WLA 142.

In order to be recognized by the back-end CE 110, the WLAs 142 are all communicatively coupled with the back-end CE 110 via the BPE communication network 150 (directly or indirectly). In some embodiments, some or all of the WLAs 142 are wireless hub devices (e.g., wireless routers, hubs, extenders, femtocells, etc.) of the BPE communication network 150, or a same subnet of the BPE communication network 150, such that each shares a network identifier (e.g., a same service set identifier (SSID), or the like). In some embodiments, some or all of the WLAs 142 are UWB-based, IoT-based, or other transceiver devices communicatively coupled with the BPE communication network 150, or a same subnet of the BPE communication network 150, such as sharing a same SSID.

As described more fully below, the back-end CE 110 can maintain a WLA/WLF data store 125. The WLA/WLF data store 125 can be maintained in any suitable non-transitory, processor-readable storage medium or media. In one implementation, the WLA/WLF data store 125 is maintained in cloud storage. In another implementation, the WLA/WLF data store 125 is maintained in one or more servers disposed on-site in the BPE 100. In another implementation, the WLA/WLF data store 125 is maintained in a same storage as the RPF resource data 148. Embodiments of the WLA/WLF data store 125 store at least the physical and logical locations of RPFs referenced to physical and logical locations of WLAs 142, and relevant logical identifiers of WLAs 142. As described herein, some WLFs 132 are pre-linked to individuals, such as where a WLF 132 is integrated into an employee's company-issued device (e.g., a corporate laptop computer, corporate smartphone, corporate smart badge, corporate vehicle, etc.), or into a personal device that has been pre-registered with the back-end CE 110. In such cases, embodiments of the WLA/WLF data store 125 can also store logical identifiers of those WLFs 132 and associations between those WLFs 132 and their pre-linked individuals.

The back-end CE 110 can also maintain a reservation event (RE) log store 127. The RE log store 127 can be maintained in any suitable non-transitory, processor-readable storage medium or media. In one implementation, the RE log store 127 is maintained in cloud storage. In another implementation, the RE log store 127 is maintained in one or more servers disposed on-site in the BPE 100. In another implementation, the RE log store 127 is maintained in a same storage as the RPF resource data 148 and/or the WLA/WLF data store 125. As described more fully below, the RE log store 127 stores reservation event details, such as reservation event identifiers, associated WLFs 132, associated WLAs 142, an event window (e.g., and/or reservation event start and end times), and any other relevant TBLL information.

As used herein, the term “event window” refers to a period of time associated with a reservation event based on, but not necessarily coincident with, the defined event start and end times (defined at the scheduler BE 116). In some cases, the event window is a period of time beginning exactly at the event start time and ending exactly at the start end time. In other cases, the TBLL engine 120 and/or the scheduler BE 116 adds a predetermined padding to the start and or end of the reservation event timing, so that the event window is a period of time beginning at or before the event start time and ending at or after the start end time. The padding can be a fixed duration, based on the type of reservation event, based on the type of RPF, etc.

Embodiments of the back-end CE 110 can be implemented in any suitable computational environment, such as by one or more servers computers physically located in the BPE 100 (i.e., on-site servers), one or more servers computers physically located remote from the BPE 100 (i.e., off-site servers), one or more cloud-based servers, or any combination thereof. As illustrated, in addition to the WLA/WLF data store 125, the back-end CE 110 includes a back-end (BE) network interface 112 to communicate with the BPE communication network 150. The back-end CE 110 also includes a TBLL engine 120 to handle instantiation, tear-down, management, and/or other features of TBLLs, and to direct TBLL-driven performance of features by other components of the back-end CE 110. Embodiments of the back-end CE 110 can also include any other components to perform, or facilitate performance of TBLL-driven features, such as a mapper BE 114, a tracker BE 115, a scheduler BE 116, and/or a BPE Infrastructure BE 118.

Each WLF 132 is associated, at least for the event window of an associated TBLL, with a particular invitee. Each WLF 132 can be deployed in a corresponding client CE 130 that is either owned or associated with the invitee separate from any particular TBLL (e.g., the invitee's personal or work laptop or smartphone, the invitee's smart badge, etc.), or is issued to the invitee in association with the particular TBLL (e.g., a temporary badge, a key fob with a portable UWB or IoT transceiver, etc.). In addition to a WLF 132, the illustrated client CE 130 includes a client-side network interface (“N/W I/F”) 138 for communicating with the BPE communication network 150. The illustrated client CE 130 also includes front-end (FE) components that functionally correspond to certain back-end components of the back-end CE 110, such as a mapper FE 134 and a scheduler FE 136. The mapper FE 134 and the scheduler FE 136 can be implemented as thin client applications, thick (“fat”) client applications, web applications, desktop applications, mobile applications, hybrid applications, cloud applications, enterprise applications, embedded applications, IoT applications, or in any other suitable manner to provide the client CE 130 access to features of the mapper BE 114 and scheduler BE 116, respectively.

The illustrated client CE 130 represents only one type of client CE 130 implementation. In general, each client CE 130 can provide one or more of the following three functions: WLF 132 functionality, invitee functionality, and/or inviter functionality. Depending on the desired functionality, the client CE 130 can be integrated into a different device environment. For example, different types of client CE(s) 130 can be integrated in smartphones, smartwatches, fitness trackers, laptops, tablets, wireless earbuds, portable gaming consoles, digital cameras, portable media players, e-readers, smart glasses or visors, smart keys, personal navigation devices, wearable health monitors, drones, remote controls, smart badges, portable speakers, portable smart appliances, smart pens, action cameras, IoT devices, etc.

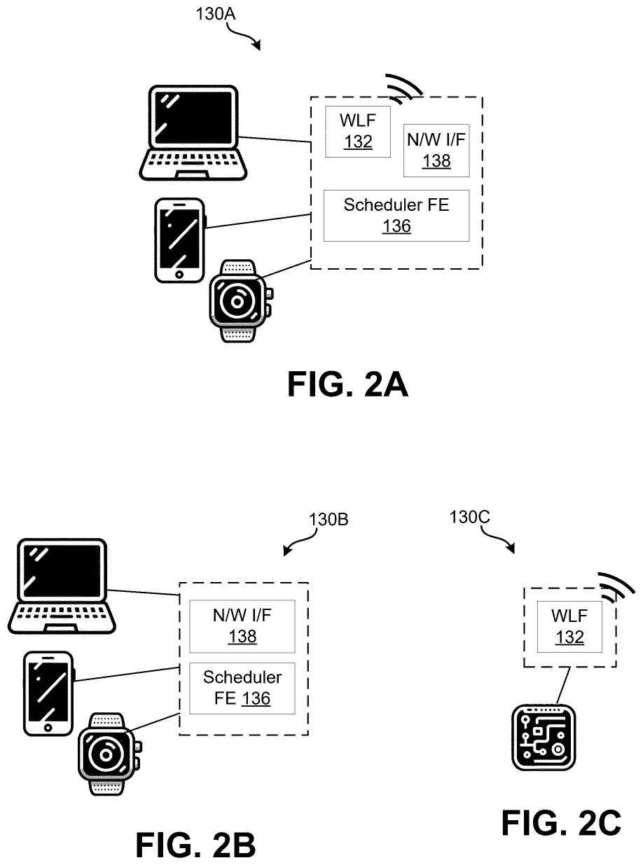

FIGS. 2A-2C show different illustrative categories of client CE 130 implementations to support different types of functionality. For example, a TBLL can begin when an inviter schedules one or more reservations of one or more RPFs for one or more particular times for one or more particular invitees. Such scheduling can be implemented using the scheduler FE 136 to interface with the scheduler BE 116 via the client-side network interface 138 and the BPE communication network 150. Thus, in some embodiments, inviter functionality can be implemented by any client CE 130 that has at least a scheduler FE 136 and a client-side network interface 138. Based on the reservations, the TBLL engine 120 instantiates one or more TBLLs, which ultimately associates one or more WLFs 132 of the one or more particular invitees with logical details of the reservations. Thus, in some embodiments, invitee functionality can be implemented by any client CE 130 that has at least an integrated WLF 132. Based on the above, it can be seen that the illustrated client CE 130A of FIG. 2A can support any or all of WLF 132 functionality, invitee functionality, and inviter functionality; the illustrated client CE 130B of FIG. 2B may only support inviter functionality; and the illustrated client CE 130C of FIG. 2C may only support WLF 132 functionality and invitee functionality. Of course, each of the illustrated client CE(s) 130 can include additional components to support additional invitee and/or inviter functions, such as a mapper FE 134.

In one category of use cases, embodiments of the back-end CE 110 can provide dynamic RPF reservation based on matching RPF resource data 148 with reservation features. An inviter (e.g., human or machine) uses a scheduler FE 136 of a client CE 130 to interface with reservation features of the scheduler BE 116 of the back-end CE 110 (e.g., via the client-side network interface 138, the BPE communication network 150, and the BE network interface 112) to generate a reservation event. Each reservation event defines a required event invitee, an event start time, and an event end time. In some implementations, the inviter can designate an RPF via the scheduler FE 136 as part of creating the reservation. In some implementations, the scheduler BE 116 can be responsible for automatically selecting the RPF for the event based at least on reservation event characteristics provided by the inviter and RPF resource data 148. In some implementations, the scheduler BE 116 can automatically generate a curated (e.g., filtered, prioritized, etc.) list of RPFs as best options for the reservation event, and the inviter can select from the list as part of creating the reservation. Any suitable scheduler FE 136 can be used for creating the reservation, such as an enterprise calendaring application, conferencing application, dedicated facility reservation application, or the like.

In connection with creating the reservation event, the scheduler BE 116 works with the TBLL engine 120 to generate an associated TBLL. As the name suggests, each TBLL represents a logical linkage between a WLF 132 associated with the event invitee and a WLA 142 associated with the event RPF (i.e., the RPF associated with the event) for an event window defined according to the event start and end times. Reservation event data, including at least TBLL data generated by the TBLL engine 120, is stored as an entry in the RE log store 127. In some cases, other reservation event data, such as data generated at or by the scheduler BE 116 is also stored in the RE log store 127 as part of the same TBLL entry, or in association with the TBLL entry.

For example, in response to creation of the reservation event, the TBLL engine 120 identifies at least a WLA 142 as associated with the event RPF, a WLF 132 as associated with the event invitee, and an event window as associated with the event start and end times. Embodiments of the TBLL engine 120 logically link this information together as a TBLL. Effectively, the TBLL provides a processor-readable definition of a linking between the WLF 132 and the WLA 142 during the time of the event window (e.g., and not otherwise). The TBLL engine 120 stores the TBLL as an entry in the RE log store 127. Each TBLL entry can be stored in any suitable processor-readable data format according to any suitable data architecture, such as a flat file, relational database, NoSQL database, object-oriented database, hierarchical database, network database, NewSQL database, time-series database, graph database, in-memory database, distributed database, data warehouse, blockchain database, cloud database, multimodal database, etc.

In some cases, a reservation event involves a single invitee reserving a single RPF for a single event window. In such cases, a single TBLL entry in the RE log store 127 can indicate the relevant WLF 132, WLA 142, and event window. In other cases, a reservation event involves a multiple invitees, and/or multiple RPFs, and/or multiple event windows (e.g., for recurring meetings). In such cases, some embodiments of the TBLL engine 120 generate a separate TBLL entry in the RE log store 127 for each unique combination. For example, each TBLL entry in the RE log store 127 indicates a particular link between one of the one or more WLFs 132, one of the one or more WLAs 142, and one of the one or more event windows (e.g., for a reservation event for X invitees, Y RPFs, and Z event windows, the TBLL engine 120 would generate X*Y*Z TBLL entries). Other embodiments of the TBLL engine 120 can use arrays, hierarchical structures, object structures, Boolean logic, and/or any other suitable technique to generate a TBLL entry in a manner that simultaneously represents multiple combinations. For example, a single TBLL entry for a reservation event having multiple X event invitees can include an X-dimensional vector indicating the X WLFs 132 associated with the X event invitees. An illustrative example of such a TBLL entry is as follows:
‘TBLL002172//UWB0602B38MR//[LT1352; G0728]//20241017_1400_60’.

The first field is an illustrative entry number. The second field is an illustrative logical identifier for the WLA 142. Any suitable type of identifier can be used. In this case, the identifier indicates in a human-readable format, that this is a UWB transceiver physically located in Building 6, Floor 2, Room B38, and that the RPF is a meeting room (MR) type. The third field is an array of WLFs 132 logical identifiers associated with two event invitees. Again, any suitable type of identifier can be used. In this case, the identifier indicates in a human-readable format, that one event invitee's WLF 132 is integrated with a company laptop and identified as ‘LT1352’, and the other event invitee's WLF 132 is a guest WLF 132 registered (e.g., temporarily as ‘G0728’. The fourth field indicates the event window. The event window can be indicated in any suitable format. In this case, the event window indicates in a human-readable format that the TBLL is valid beginning on Oct. 17, 2024 (‘20241017’) at 14:00 and lasts for 60 minutes. These fields are illustrative only. Each TBLL entry can include any suitable fields in any suitable order.

In some implementations, additional information is stored along with each TBLL entry (e.g., as part of the same entry, associated in a relational or hierarchical structure, etc.). In some implementations, the TBLL engine 120 associates each TBLL entry with a unique event identifier. In some such implementations, the event identifier is used to associate all TBLL entries relating to (e.g., generated from) the same reservation event. For example, in implementations where the TBLL engine 120 generates a separate TBLL entry for each combination of invitee, RPF, and event window, a common event identifier would be shared by all TBLL entries for a meeting having multiple invitees, RPFs, and/or event windows. Additionally or alternatively, the unique event identifier can be used to link the one or more TBLL entries to their corresponding reservation event in the scheduler BE 116. In some embodiments, each TBLL entry can include additional human-readable and/or processor-readable data for the associated TBLL and/or associated reservation event, such as reservation event details (e.g., event name), invitee details (e.g., invitee name, employee identification number, access credentials, work location, device identifier(s), etc.), inviter details, RPF details (e.g., physical location, available resources, access controls, etc.), etc.

As described herein, the generation of TBLLs and associated entries by the TBLL engine 120, thereby logically linking particular WLFs 132 and WLAs 142 during particular event windows, enables several types of features to be provided in relation to each reservation event. One such feature is that, during the event window, the mapper BE 114 can facilitate mapping (e.g., using wireless mapping features described herein) of the event invitee's WLF 132 to the event RPF's WLA 142, thereby automatically directing the event invitee to the physical location of the appropriate RPF in time for the reservation event based on the TBLL entry. Another such feature is that, during the event window, a tracker BE 115 can facilitate tracking of event invitees (e.g., based on information from the mapper BE 114 and the RE log store 127) to determine, for example, which event invitees are in attendance, which are on the way, which may need a reminder or nudge, how long an event invitee stayed in the meeting, etc. Another such feature is that, during the event window, the BPE infrastructure BE 118 can direct RPF displays 144 to display relevant information for the reservation event, such as by displaying a meeting name outside a meeting room, a current time, an RPF identifier, etc. Another such feature is that, during the event window, the BPE infrastructure BE 118 can direct RPF access controls 146 to grant or deny access to event invitees based on presence and/or proximity of their associated WLFs 132 in accordance with the TBLL entries. Another such feature is that, at any time (e.g. prior to the start of the event window), the scheduler BE 116 can dynamically update characteristics of the reservation event, such as event attendees, event RPF, etc., and the TBLL engine 120 can automatically update TBLL entries in the RE log store 127 in response to those reservation event updates. Such an automated update to the TBLL entries can cause an automatic update to any mapping provided by the mapper BE 114; tracking provided by the tracker BE 115; control of RPF displays 144, RPF access controls 146, and/or other BPE infrastructure 140 by the BPE infrastructure BE 118, etc.

To further explain and expand on features of embodiments described herein, two types of use cases will be described. Embodiments can be designed to perform one or more, or even all, of these categories of use cases. As such, features or components described in the context of a particular use case are not intended to be restricted to that use case; rather, any features or components can be applied and/or used in the context of any use case.

### Meeting Room Use Case

As one illustrative type of use case, a work meeting is being scheduled for several employees and/or guests of a company. For the sake of this example, it is assumed that a large corporate headquarters complex is the BPE 100, and a large number of meeting rooms in the complex is the relevant set of RPFs (i.e., there may be other RPFs, but those are not considered in this example). There is a BPE communication network 150 covering the portion of the BPE 100 that includes the relevant RPFs. For example, the BPE communication network 150 can include on or more WANs, LANs, etc., all accessible to by the back-end CE 110.

Each RPF (i.e., meeting room) may have associated resources (e.g., stored in the RPF resource data 148), such as a supported occupancy (e.g., how many people can comfortably fit in the meeting room at one time, number of chairs, number of conference table positions, etc.), networking support (e.g., what types of physical and/or wireless communication ports are available, etc.), audiovisual (A/V) support (e.g., what types of physical and/or wireless A/V ports are available, in-room monitors, in-room audioconferencing and/or videoconferencing equipment, etc.). One or more of the RPF displays 144 can also be disposed inside of, at the entrance to, adjacent to, or otherwise in connection with (e.g., as part of a floor or building map) the RPF. These RPF displays 144 are controllable (e.g., dynamically updated) by the back-end CE 110, such as to display the name of the meeting room, a name of a meeting occurring in the meeting room, a schedule associated with the meeting room, attendee names, etc. One or more physical and/or logical RPF access controls 146 can also be integrated with, or otherwise associated with, the RPF. The RPF access controls 146 may include electronic physical locks (e.g., on one or more doors of the RPF, on A/V or file cabinets in the RPF, etc.) and/or electronic logical locks (e.g., one or more passcodes, encryption keys, access codes, etc. to enable access to the RPF and/or to any RPF resources). In some cases, the RPF access controls 146 are controllable by the back-end CE 110 (e.g., the back-end CE 110 can automatically unlock the meeting room door at an appropriate time). In other cases, the RPF access controls 146 are not controllable by the back-end CE 110, but can be dynamically (e.g., temporarily provided to or associated with one or more WLFs 132, such as described below.

One or more inviters (e.g., one of the attendees, a secretary or other human individual, or an automated computational agent) use the scheduler FE 136 to define aspects of the meeting (i.e., the reservation event). For example, the inviter(s) define event attendees, and event start and end times for the meeting. One or more event invitees may subsequently forward the meeting to others, thereby becoming another inviter and adding event invitees. An RPF is also assigned as the event RPF for the reservation event. As described herein, the inviter(s) and/or the back-end CE 110 selects an appropriate RPF as the event RPF (at least initially, as described below). Each RPF has a location that is associated at the back-end CE 110 with the logical and physical locations of a WLA 142 (e.g., a single physical transceiver, a virtual WLA based on signal combining, etc.) in the WLA/WLF data store 125.

Embodiments of the TBLL engine 120 use the reservation data from the scheduler BE 116 to generate a TBLL. The TBLL engine 120 can associate one or more WLFs 132 for each of the one or more event attendees for the reservation event. As described above, in some cases, some or all WLFs 132 are pre-linked with individuals, and those pre-links can be stored in the WLA/WLF data store 125. In such cases, the TBLL engine 120 can query the WLA/WLF data store 125 to see whether the event attendee is pre-linked with a WLF 132, and the TBLL engine 120 can associated the reservation event with that pre-linked WLF 132 for that event attendee. In cases where an event attendee is not pre-linked with a WLF 132, embodiments of the TBLL engine 120 (or other components of the back-end CE 110) can link the event attendee with a WLF 132. In some such cases, the link is generated by prompting the event attendee to register a device (having an integrated WLF 132) with the back-end CE 110. For example, a meeting invite emailed to the event invitee includes a web link (e.g., a URL), scannable code (e.g., a QR code), or other means by which to provide relevant data for registering the device. In other such cases, the link is generated by temporarily assigning one of a pool of assignable WLFs 132 (e.g., portable transceivers, smart cards, key fobs, laptop dongles, etc.) to an event attendee for an event window associated with the reservation event.

Embodiments of the TBLL engine 120 also assign an event window to the TBLL for the reservation event. As noted above, the event window may or may not be coincident with the defined event start and end times (defined at the scheduler BE 116). For example, in this example, it may be desirable to begin the TBLL (i.e., establish the logical linking of associated WLFs 132 and WLAs 142) fifteen minutes prior to the meeting's scheduled start time and end the TBLL ten minutes after the meeting's scheduled end time. That way, event invitees will be able to begin using the mapping features of the mapper BE 114 with enough time to arrive at the meeting before the start time, event invitees arriving a bit early or leaving a bit late will be able to take advantage of features provided by the BPE infrastructure BE 118 (e.g., updates to RPF displays 144 and/or RPF access controls 146), etc.

Some embodiments can handle the event window assignment in other ways. In one implementation, the event window begins (i.e., the TBLL becomes active) some time prior to the reservation event's scheduled start time and ends only when a designated individual (e.g., the inviter) tells the back-end CE 110 that the meeting is over. For example, when the meeting is finished, the designated individual uses the scheduler FE 136 to indicate that the meeting has ended; the scheduler FE 136 informs the scheduler BE 116, which informs the TBLL engine 120, and the TBLL engine 120 updates the RE log store 127 to end any associated TBLLs. In another implementation, the event window begins (i.e., the TBLL becomes active) some time prior to the reservation event's scheduled start time and ends only when all event invitees have left the meeting room. For example, the tracker BE 115 monitors presence of event invitees to determine when they have left the meeting room; when everyone has left, the tracker BE 115 informs the TBLL engine 120, and the TBLL engine 120 updates the RE log store 127 to end any associated TBLLS.

Thus, creation of the reservation event using the scheduler FE 136 and the scheduler BE 116 results in creation of one or more TBLL entries (e.g., and other associated information and/or entries) in the RE log store 127. As described herein, the generation of the TBLLs and associated entries by the TBLL engine 120 logically links WLFs 132 of the event invitees to the WLA 142 of the event RPF during the event window, thereby enabling associated features. In some embodiments, the start of the event window triggers the mapper BE 114 to interface with the mapper FE(s) 134 of the client CE(s) 130 of the event invitee(s) to help the event invitee(s) find the event RPF. Some embodiments of the mapper BE 114 implement wireless mapping based on tracking positions of the linked WLF(s) 132 relative to the event RPF.

As described herein, some embodiments of the WLF(s) 132 and WLA(s) 142 use UWB transceivers. As used herein, a UWB transceiver can be implemented as either a UWB “tag” or “anchor” (e.g., although the WLA 142 is referred to as an “anchor,” it can be implemented by a UWB tag). Further, although a UWB transceiver is typically considered as a component of a UWB tag or anchor, the term UWN transceiver is used herein as a generic term referring to a UWB tag or anchor, including any other components integrated therein. For example, a UWB tag or anchor typically includes several functional blocks, such as a UWB antenna, a UWB transceiver chip (e.g., to generates UWB pulses, modulate data onto the pulses, measures time of flight for received pulses, etc.), a microcontroller unit (MCU) (e.g., including one or more processors or microcontrollers for managing overall system operation, distance calculations, timing synchronization, etc.), a power management system (e.g., power management circuitry, power supply, etc.), a memory system (e.g., to store firmware, configuration data, temporary variables, etc.), a communication interface (e.g., one or more wired and/or wireless interfaces), a signal processing system (e.g., a digital signal processor (DSP) to process UWB signals, implement algorithms for distance estimation and positioning calculations, etc.), one or more sensors (e.g., an inertial measurement unit (IMU) and/or gyroscopic sensor to improve tracking accuracy, environmental sensors, etc.), and or any other suitable components. Any of those and/or other components can be considered herein to be part of the UWB transceiver.

Such UWB transceivers can be used for location tracking (i.e., by the mapper BE 114 to help direct a WLF 132 to a WLA 142) based on distance measurement and corresponding position calculation. For example, the WLFs 132 can initially seek to establish communication links with any sufficiently proximate WLAs 142. This can involve a handshake process to synchronize clocks and establish the communication link. In some embodiments, the WLFs 132 can periodically transmit UWB pulses (e.g., short-duration, high-frequency signals), which are received by the WLAs 142. Time-of-flight (TOF) for each pulse is measured, indicating the time it takes for the signal to travel from the WLF 132 to each WLA 142, and also indicating (based on the speed of light) the distance between the WLF 132 and each WLA 142. This data is obtained by the back-end CE 110 (e.g., by the mapper BE 114) from multiple WLAs 142 to generate a set of distance data, and one or more algorithms (e.g., a trilateration algorithm) is applied to calculate a three-dimensional physical position of the WLF 132 relative to known physical positions of the WLAs 142. In some implementations, additional information, such as IMU data, is used to verify and/or improve the positioning calculation (e.g., to compensate for temporary UWB signal obstructions, or the like). The position of the WLF 132 can be updated periodically according to an update rate, and filtering and/or other algorithms can be used (e.g. Kalman filtering) to reduce noise in the position data, such as by smoothing out erratic movements.

In some other embodiments, the WLF(s) 132 and WLA(s) 142 use wireless fidelity (WiFi) transceivers. Each WiFi transceiver can include similar components to those of a UWN transceiver described above, such as a WiFi antenna, a WiFi transceiver chip, a MCU, a power management system, a communication interface, a signal processing system, etc. The WiFi transceivers can be used for location tracking (i.e., by the mapper BE 114 to help direct a WLF 132 to a WLA 142) in a similar manner to what is described above for the UWB transceivers. For example, the WiFi chipset on the WLF 132 detects and measures the signal strength (received signal strength indicator, RSSI) from nearby WiFi access points (APs) integrated in WLAs 142. As described above, the physical locations of the WLAs 142 (corresponding to the physical locations of the WiFi APs) are known. The back-end CE 110 (e.g., the mapper BE 114) can apply one or more algorithms, such as triangulation or trilateration, to the RSSI values from multiple WLAs 142 to estimate the position of the WLF 132. Essentially, the measured signal strength relative to a particular WLA 142 is assumed to increase as the WLF 132 approaches that WLA 142. Some implementations can account for signal attenuation and/or reflection due to obstacles. Some implementations provide additional features, such as comparing the WLF's 132 signal strength measurements to a database of previously measured signal strengths at locations around the BPE 100 to determine the WLF 132 location (e.g., referred to as WiFi fingerprinting). Some implementations can also integrate such WiFi location techniques with other technologies, such as GPS, Bluetooth beacons, cellular femtocells, IMUs, etc. to improve location accuracy and/or reliability.

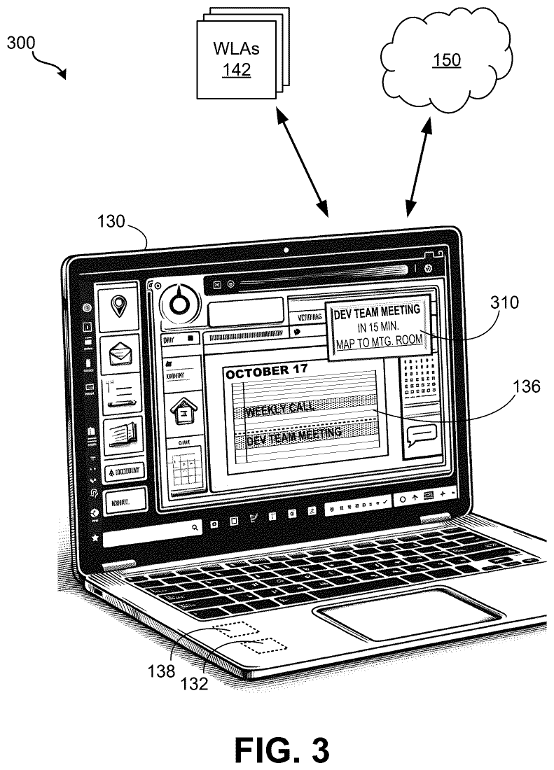

For the sake of illustration, FIG. 3 shows an example TBLL-based RPF scheduling environment 300. The environment 300 includes a client CE 130, illustrated as an invitee laptop. It is assumed that a meeting (reservation event) was previously set up for this invitee (an event invitee), and the TBLL engine 120 previously generated at least one corresponding TBLL entry. As illustrated, the client CE 130 includes an integrated WLF 132 to communicate with one or more WLAs 142 and a client-side network interface 138 to communicate with a BPE communication network 150. The laptop is also presently displaying an illustrative graphical user interface (GUI) portion of a scheduler FE 136. In the illustrated environment 300, the start of an event window defined in the TBLL entry has triggered a pop-up window 310 to appear on the laptop display. The pop-up window 310 indicates that the “DEV TEAM MEETING” is beginning in fifteen minutes and provides clickable prompt to access the mapper FE 134 for mapping to the event RPF. Clicking on the prompt can open a GUI portion of the mapper FE 134, which can interface with the mapper BE 114 of the back-end CE 110 to provide mapping features (e.g., wireless mapping).

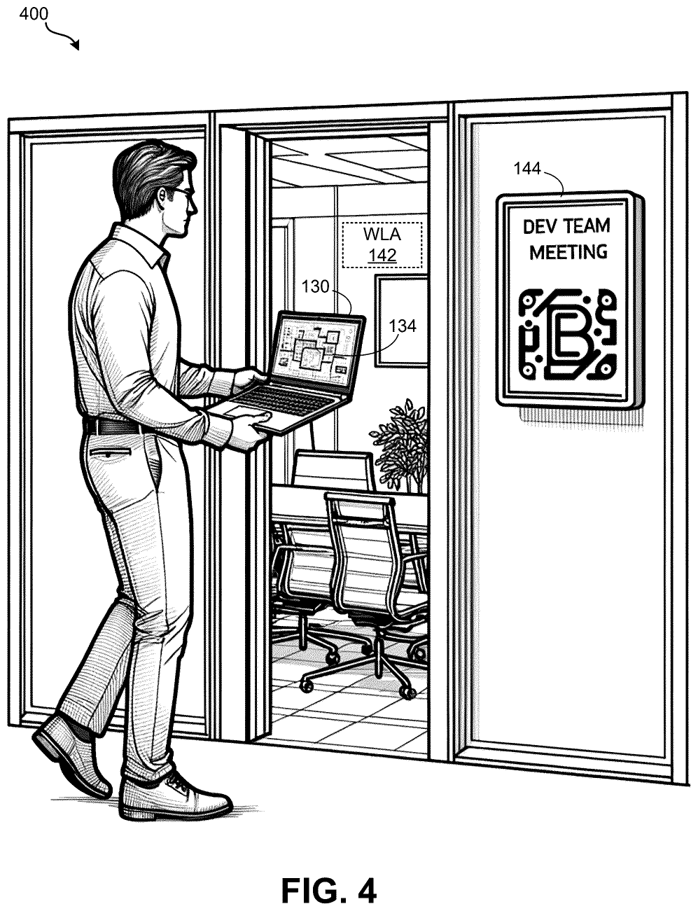

FIG. 4 shows an illustrative subsequent scene 400 extending the example TBLL-based RPF scheduling environment 300 of FIG. 3. The scene 400 shows the invitee (the event invitee) arriving at a meeting room (i.e., the event RPF) scheduled for the “DEV TEAM MEETING.” The invitee is holding the laptop (client CE 130) of FIG. 3, which is now displaying a GUI portion of the mapper FE 134 to guide the invitee to the meeting room. As described above, the mapping uses the linked WLF 132 and WLA 142 defined by a relevant TBLL entry in the RE log store 127, the known WLA 142 locations from the WLA/WLF data store 125, the known association of the invitee to the WLF 132, and wireless mapping between the WLF 132 relative to one or more WLAs 142 (including the linked WLA 142).

As described above, embodiments of the tracker BE 115 can exploit the TBLL-based RPF scheduling to provide tracking features. For example, during the event window, the tracker BE 115 can monitor whether and/or when the invitee (i.e., the WLF 132) is in a location associated with being in the meeting room (i.e., in attendance of the meeting). This information can be used automatically to track meeting attendance, meeting duration, how long the invitee stayed in the meeting, etc. In some embodiments, the tracker BE 115 can determine whether the invitee has begun heading in the direction of the meeting within a certain time before the start of the meeting; if not, the tracker BE 115 can send (or direct another component to send) a reminder to encourage the invitee to head to the meeting. In some embodiments, the tracker BE 115 and the mapper BE 114 work together to detect whether the invitee appears to be lost, and can send (or direct another component to send) a message to the invitee, accordingly.

The scene 400 of FIG. 4 also shows a RPF display 144 located adjacent to the entrance to the meeting room. As noted above, the BPE infrastructure BE 118 can direct the RPF displays 144 to display any relevant information. In the illustrated scene 400, the RPF display 144 is showing the company logo and the meeting name. The same (or other) RPF display 144 could additionally or alternatively show information, such as a welcome message for the specific invitee triggered by detecting proximity of the WLF 132, a count or list of current attendees, a meeting room identifier (e.g., a room number), a current time, whether access restrictions are in place (e.g., “AUTHORIZED DEV TEAM MEMBERS ONLY”), etc.

Although none are explicitly shown, the meeting room can have any suitable types of physical and/or electronic access controls (RPF access controls 146). For example, there can be a door with an electronic lock, in-room network access, etc. As described above, embodiments of the BPE infrastructure BE 118 can direct the RPF access controls 146 to grant access only to those WLFs 132 (or invitees associated with WLFs 132) defined as having access during the relevant event window by a corresponding TBLL entry in the RE log store 127. For example, as the invitee approaches the door to the meeting room, the tracker BE 115 detects proximity of the WLF 132, the TBLL engine 120 determines that the WLF 132 is logically linked with the WLA 142 of the meeting room (event RPF) in a presently active event window, and the TBLL engine 120 informs the BPE infrastructure BE 118, and the BPE infrastructure BE 118 directs the relevant RPF access controls 146 to automatically unlock the door for the invitee.

In some embodiments, the access privileges are transferred to one or more other devices of the invitee. For example, the invitee attempts to unlock the door to the meeting room using individual credentials (e.g. a badge, passcode, key fob, biometrics, etc.); or the invitee attempts to access in-room A/V equipment, wireless networking, file or equipment cabinets, etc. using individual credentials. In response to such an attempt, TBLL engine 120 determines whether the credentials are associated with a particular individual, whether the particular individual is associated with a WLF 132 that is logically linked with the WLA 142 of the meeting room (event RPF) in a presently active event window according to a TBLL entry in the RE log store 127, and whether the employee is thereby authorized to use the credentials. The TBLL engine 120 can then inform the BPE infrastructure BE 118 of the results of the determinations, and the BPE infrastructure BE 118 can direct the relevant RPF access controls 146 to grant or deny access, accordingly.

As described above, another feature enabled by TBLL-based RPF scheduling is the ability by the scheduler BE 116 to automatically select RPFs and/or dynamically update selection of RPFs based on updates to characteristics of the reservation event. In the example meeting use case, the reservation event can include a number of characteristics, and the event RPF can be automatically selected and/or updated according to fit those characteristics. For example, the reservation event has a number of invitees, and the meeting room (event RPF) can be selected to accommodate at least that number of invitees. This can avoid scheduling of meeting rooms that are too large or too small for the number of invitees. Further, the number of invitees may change at any time prior to the start of the meeting, such as when invitees decline the meeting, when invitees are added to the meeting, etc. In such cases, some embodiments can automatically update the selection of the meeting room, as needed, to fit the number of attendees most appropriately. This selection can be based on information about the meeting room stored in the RPF resource data 148, such as the number of chairs in the room, number of outlets in the room, etc.

In some embodiments, the RPF resource data 148 indicates a present resource configuration in the room and one or more potential resource configurations for the room. In some implementations, the scheduler BE 116 automatically selects (or suggests) the event RPF based on the present resource configuration in the room. In some implementations, the scheduler BE 116 automatically selects (or suggests) the event RPF based on one or more potential resource configurations for the room. In cases where the present resource configuration does not satisfy the meeting characteristics, some embodiments of the scheduler BE 116 can automatically notify the inviter, facilities personnel, and/or other relevant parties to reconfigure the room resources prior to the meeting.

Some embodiments can automatically select or suggest one or more event RPFs based on additional considerations. As one example, the meeting reservation may indicate that certain A/V resources (e.g., web conferencing) support is needed in the room, and the scheduler BE 116 will select or prioritize event RPFs having those resources available. As another example, the scheduler BE 116 can select or suggest one or more event RPFs based on the locations of the RPFs relative to locations of the invitees. For instance, if all of the invitees are in a certain region (e.g., building) of the BPE 100, the scheduler BE 116 will select or prioritize event RPFs in or closest to that region of the BPE 100. As a related example, the scheduler BE 116 may have access to the calendars of some or all of the invitees, such that the scheduler BE 116 can be aware of whether any invitees have adjacent appointments (i.e., appointments close in time to the reservation event). In such cases, embodiments of the scheduler BE 116 can seek to scheduler BE 116 will select or prioritize event RPFs most convenient to the locations of those adjacent appointments, if possible. Any of these or other additional considerations can be dynamically reevaluated with changes to the meeting characteristics, such as changes to the list of invitees, changes to RPF resources, changes to invitee calendars, etc.

As described above, any updates to the scheduling (e.g., to the selected event RPF, invitee list, etc.) are conveyed automatically to the TBLL engine 120, and the TBLL engine 120 automatically updates any affected TBLL entries in the RE log store 127, accordingly. As such, dynamic updates to scheduling can generate dynamic updates to TBLL-based features, such as an automatic update to any mapping provided by the mapper BE 114, to tracking provided by the tracker BE 115, and/or to control of BPE infrastructure 140 by the BPE infrastructure BE 118. For example, even if there is a last-minute change to the meeting location, the mapper BE 114 will still guide the event invitees to the proper event RPF, any association between the invitee's credentials and access-controlled resources of the event RPF will automatically be updated, etc.

### Parking Lot Use Case

In a second illustrative type of use case, a parking space is scheduled for an invitee (i.e., and/or a vehicle associated with the invitee). In this example, it is assumed that a large parking lot is the BPE 100, and the parking lot includes a large number of parking spaces as the relevant set of RPFs (i.e., there may be other RPFs, but those are not considered in this example). For example, the parking lot can be a stand-alone parking lot, or a parking lot at a corporate office, a hotel, a concert or sports venue, etc. There is a BPE communication network 150 covering the portion of the BPE 100 that includes the relevant RPFs. For example, the BPE communication network 150 can include on or more WANs, LANs, etc., all accessible to the back-end CE 110.

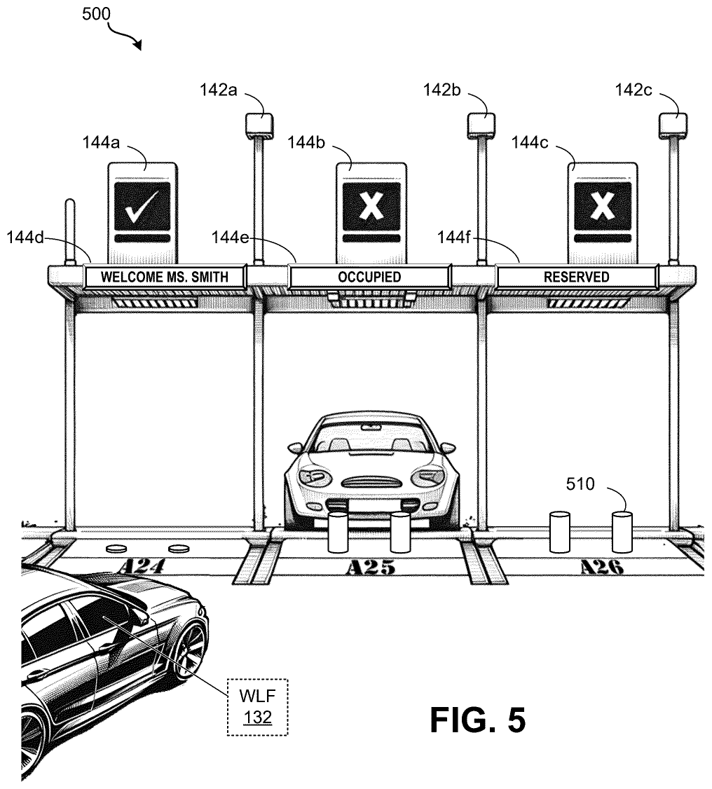

For the sake of illustration, FIG. 5 shows an illustrative scene 500 corresponding to an example parking lot use cases. The scene 500 shows the invitee (the event invitee) arriving by car at a parking space (i.e., the event RPF) that was previously scheduled for the invitee. As one example, when the invitee was invited to a meeting or purchased tickets to an event, a parking lot was automatically reserved in relation to the meeting or event. As another example, when the invitee checked in to a hotel or venue, a parking lot was automatically reserved. As described above, the reservation triggers generation by the TBLL engine 120 of at least one TBLL entry defining a TBLL between one of a number of WLAs 142 and one of a number of WLFs 132 during an event window. Each of the WLAs is associated with one of the parking spaces, and the one of the WLFs 132 is associated with the invitee. FIG. 5 shows the WLF 132 as generally disposed in the vehicle. For example, the WLF 132 is integrated into one of the invitee's devices (e.g., the invitee's smartphone, laptop, vehicle, etc. is the client CE 130), or the WLF 132 is provided to the invitee (e.g., a portable transceiver device handed to the invitee upon check-in is the client CE 130).

The illustrated scene 500 shows three parking spaces of a parking lot, labeled ‘A24’, ‘A25’, and ‘A26’. Each space has a physical WLA 142 proximate to the space. Each space also has multiple RPF displays 144 indicating relevant TBLL-based information about the space. It is assumed in FIG. 5 that space ‘A24’ is reserved for Ms. Smith, and Ms. Smith is approaching the space in her vehicle. RPF display 144b indicates that space ‘A25’ is not for Ms. Smith, and RPF display 144e more specifically indicates that space ‘A25’ is presently occupied by another vehicle. RPF display 144c indicates that space ‘A26’ is also not for Ms. Smith, and RPF display 144f more specifically indicates that space ‘A26’ is presently reserved. Both spaces ‘A25’ and ‘A26’ are further physically blocked by raised bollards 510 (i.e., RPF access controls 146). In Ms. Smith's space (space ‘A24’), RPF display 144a indicates that the space is for Ms. Smith, and RPF display 144d more specifically displays “WELCOME MS. SMITH.” Further, the bollards in front of Ms. Smith's space are automatically lowered as her WLF 132 approaches the WLA 142a of the space.

In some cases, each RPF (i.e., parking space) is considered as a respective instance of a set of effectively identical RPFs. In other cases, each RPF has associated resources (e.g., stored in the RPF resource data 148), such as a size (e.g., whether it supports trucks, large cars, small cars, motorcycles, bicycles, busses, etc.), proximity to other resources (e.g., proximity to an elevator, lot exit, building entrance, etc.), access restrictions (e.g., whether there are physical access controls, whether it is a visitor space, whether it is a reserved space, etc.), access to charging facilities (e.g., whether it is an electric vehicle space with a charger and/or the type of charger, etc.), etc. One or more of the RPF displays 144 can also be disposed in and/or adjacent to the parking space, and/or in other locations in the parking lot. One or more physical and/or logical RPF access controls 146 can also be integrated with, or otherwise associated with, the RPF. For example, the RPF access controls 146 may include an electronic fence and/or gate surrounding some or all of the parking lot, electronically controlled bollards (as illustrated) or other physical access controls at the parking space, etc. In some cases, the RPF access controls 146 are controllable by the back-end CE 110 (e.g., the back-end CE 110 can automatically open gates, etc. when appropriate during the event window). In other cases, the RPF access controls 146 are not controllable by the back-end CE 110, but can be dynamically (e.g., temporarily provided to or associated with one or more WLFs 132), such as described below.

Aspects of the parking lot use cases are similar to those of the meeting room use case. For example, one or more inviters (e.g., one of the attendees, a secretary or other human individual, or an automated computational agent) use the scheduler FE 136 to reserve the parking spot for the invitee (i.e., the reservation event), including indicating event start and end times for usage of the parking space. An RPF (a parking space) is assigned as the event RPF for the reservation event. As described herein, the inviter(s) and/or the back-end CE 110 selects an appropriate RPF as the event RPF (at least initially, as described below). Each RPF has a location that is associated at the back-end CE 110 with the logical and physical locations of a WLA 142 (e.g., a single physical transceiver, a virtual WLA based on signal combining, etc.) in the WLA/WLF data store 125.

Embodiments of the TBLL engine 120 use the reservation data from the scheduler BE 116 to generate a TBLL. The TBLL engine 120 can associate one or more WLFs 132 for each of the one or more event attendees for the reservation event. Embodiments of the TBLL engine 120 also assign an event window to the TBLL for the reservation event, which may or may not be coincident with the defined event start and end times (defined at the scheduler BE 116). In this example, it may be desirable to begin and/or end the TBLL (i.e., establish the logical linking of associated WLFs 132 and WLAs 142) at or close to the reserved start and end times for the parking space. In certain cases (also in the meeting room use case, or any other use cases), different event windows can be established for different features. For example, a TBLL becomes valid for use by the mapper BE 114 fifteen minutes prior to the start of the parking space reservation to provide time for the space, but the TBLL becomes valid for use by the BPE infrastructure BE 118 only at the start of the reservation time to prevent early access to the parking space. As another example, the BPE infrastructure BE 118 can be configured so that a TBLL is usable to grant access to a main gate (e.g., at the main entrance to the parking lot) five minutes prior to the start of the parking space reservation time, but the same TBLL is usable to grant access to RPF access controls 146 at the space itself only as of the start of the parking space reservation time. Alternatively, different TBLL entries can be generated by the TBLL engine 120 to account for such cases and/or otherwise to add flexibility.

As described herein, the generation of the TBLLs and associated entries by the TBLL engine 120 logically links the WLF 132 of the event invitee to the WLA 142 of the event RPF (the parking space) during the event window, thereby enabling associated features. In some embodiments, the start of the event window triggers the mapper BE 114 to interface with the mapper FE(s) 134 of the client CE(s) 130 of the event invitee(s) to help the event invitee(s) find the event RPF. For example, the mapper BE 114 can implement wireless mapping techniques (e.g., using UWB, WiFi, etc.) to guide the invitee to the parking space via any suitable client CE(s) 130 of the invitee. In one implementation, the guidance is displayed via a GUI of the mapper FE 134 on the invitee's smart phone. In another implementation, the guidance is displayed via a GUI of the mapper FE 134 on the invitee's in-vehicle display and/or navigation system.

As described above, embodiments of the tracker BE 115 can exploit the TBLL-based RPF scheduling to provide tracking features, such as to detect when and/or for how long the invitee's vehicle is presently occupying the reserved space, whether the invitee appears to be late or lost, etc. Further, embodiments of the BPE infrastructure BE 118 can direct the RPF displays 144 to display any relevant information, such as illustrated in FIG. 5. Further, embodiments of the BPE infrastructure BE 118 can control any physical and/or electronic access controls (RPF access controls 146) associated with the parking lot and/or parking space, such as the illustrated bollards. In some cases, the parking space has additional infrastructure resources, such as an EV charging station, recreational vehicle (RV) service ports, etc. In some such cases, embodiments of the BPE infrastructure BE 118 can electronically control access to those resources, such as by powering on or off the EV charging station during some or all of the event window, or when the WLF 132 is in proximity to the WLA 142. Further, as described above, embodiments can dynamically update TBLL entries to adapt to updates to scheduling.

The above use cases represent only a subset of the possible uses of TBLL-based RPF scheduling. As one example, similar techniques and features can be applied to an airport context. When a traveler checks in, a WLF 132 in the traveler's smartphone is logically linked to a WLA 142 associated with their departure gate during an event window that is active until take-off, or the like. The resulting TBLL(s) can help automatically map the traveler to the proper gate, track whether the traveler is in the gate area, dynamically update airport displays and access controls, etc. As another example, similar techniques and features can be applied to a hotel context. When a guest checks in, a WLF 132 in the traveler's smartphone is logically linked to a WLA 142 associated with their hotel room (and/or parking space, restaurant, conference center, etc.) during an event window that is active until check-out, or the like. The resulting TBLL(s) can help automatically map the guest to the proper floor and room, track whether the guest is in their room, dynamically update room (and/or hotel) displays and access controls, etc.

### Computational Systems and Methods

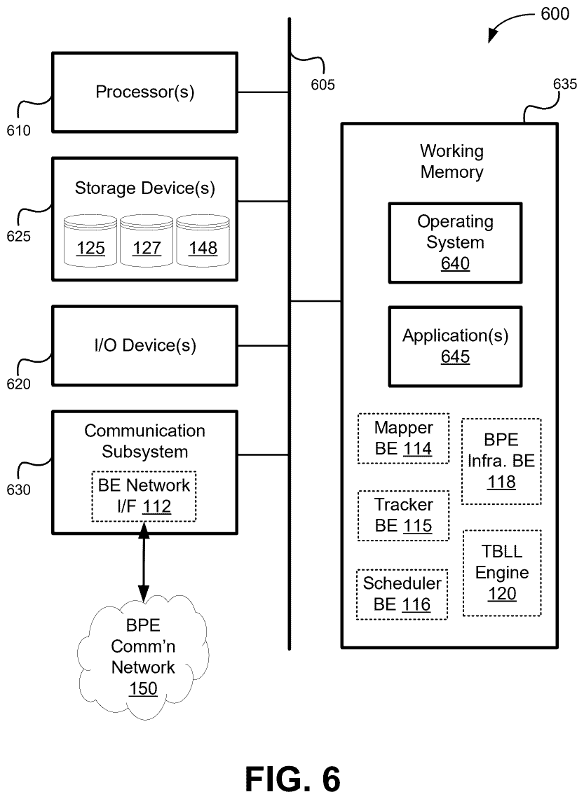

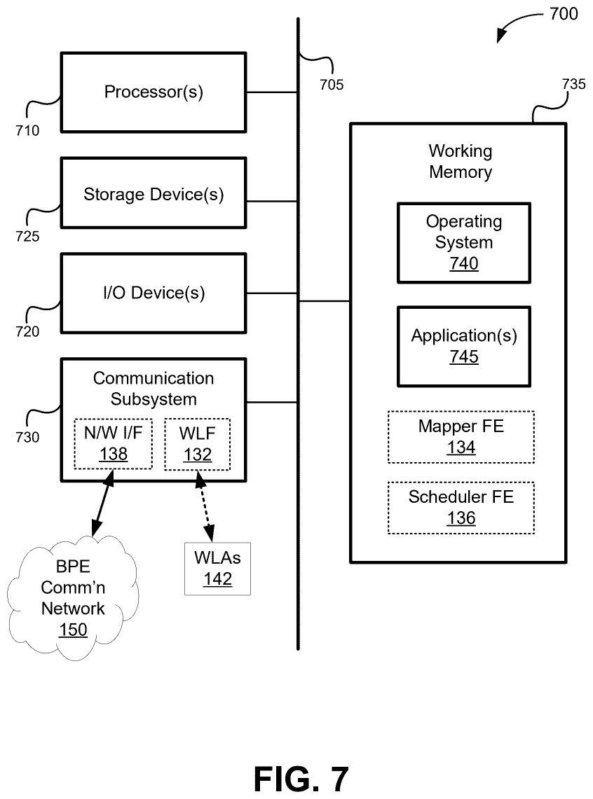

Any of the above systems and use cases can be implemented using one or more computational systems and/or one or more processor-implemented methods. FIGS. 6 and 7 show illustrative computational systems 600 and 700 for implementing embodiments of a back-end CE 110 or a client CE 130, respectively, according to embodiments described herein. FIGS. 6 and 7 provide schematic illustrations of embodiments of a computer system 600, 700 that can implement various system components and/or perform various steps of methods provided by various embodiments described herein. It should be noted that FIGS. 6 and 7 are meant only to provide a generalized illustration of various components, any or all of which may be utilized as appropriate. FIGS. 6 and 7, therefore, broadly illustrate how individual system elements may be implemented in a relatively separated or relatively more integrated manner.

Turning first to FIG. 6, a computer system 600 is shown comprising hardware elements that can be electrically coupled via a bus 605 (or may otherwise be in communication, as appropriate). The hardware elements may include one or more processors 610, including, without limitation, one or more general-purpose processors and/or one or more special-purpose processors (such as digital signal processing chips, graphics acceleration processors, video decoders, and/or the like); one or more input/output (I/O) devices 620, which can include, without limitation, a mouse, keyboard, remote control, button, switch, display device, printer, and/or the like.

The computer system 600 may further include (and/or be in communication with) one or more non-transitory, processor-readable storage devices 625, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable and/or the like. Such storage devices may be configured to implement any appropriate data stores, including, without limitation, various file systems, database structures, and/or the like. As illustrated, embodiments of the storage devices 625 can implement the WLA/WLF data store 125, the RE log store 127, and/or the RPF resource data 148 (e.g., as described with reference to FIG. 1).

The computer system 600 can also include a communications subsystem 630, which can include, without limitation, a modem, a network card (wireless or wired), an infrared communication device, a wireless communication device, and/or a chipset (such as a Bluetooth™ device, an 802.11 device, a WiFi device, a WiMax device, cellular communication device, etc.), and/or the like. The communications subsystem 630 may permit data to be exchanged with a network, other computer systems, and/or any other devices described herein. As illustrated, embodiments of the communications subsystem 630 implement the BE network interface 112 for communicating with at least the BPE communication network 150 (e.g., as described with reference to FIG. 1).

In many embodiments, the computer system 600 further comprises a working memory 635, which can include a RAM or ROM device, as described above. The computer system 600 also can comprise software elements, shown as currently being located within the working memory 635, including an operating system 640, device drivers, executable libraries, and/or other code, such as one or more application programs 645, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general-purpose computer (or other device) to perform one or more operations in accordance with the described methods. As illustrated, the application programs 645 can include (or the working memory 635 can be otherwise programmed to implement) the mapper BE 114, the scheduler BE 116, the tracker BE 115, the BPE infrastructure BE 118, and/or the TBLL engine 120.

A set of these instructions and/or codes might be stored on a non-transitory computer-readable storage medium, such as the non-transitory storage device(s) 625 described above. In some cases, the storage medium might be incorporated within a computer system, such as computer system 600. In other embodiments, the storage medium might be separate from a computer system (e.g., a removable medium, such as a compact disc), and/or provided in an installation package, such that the storage medium can be used to program, configure, and/or adapt a general-purpose computer with the instructions/code stored thereon. These instructions might take the form of executable code, which is executable by the computer system 600 and/or might take the form of source and/or installable code, which, upon compilation and/or installation on the computer system 600 (e.g., using any of a variety of generally available compilers, installation programs, compression/decompression utilities, etc.), then takes the form of executable code.

Turning to FIG. 7, a computer system 700 is shown for implementing embodiments of a client CE 130, according to some embodiments described herein. The computer system 700 includes hardware elements that can be electrically coupled via a bus 705 (or may otherwise be in communication, as appropriate). The hardware elements may include one or more processors 710, including, without limitation, one or more general-purpose processors and/or one or more special-purpose processors (such as digital signal processing chips, graphics acceleration processors, video decoders, and/or the like); one or more input/output (I/O) devices 720, which can include, without limitation, a mouse, keyboard, remote control, button, switch, display device, printer, and/or the like.

The computer system 700 may further include (and/or be in communication with) one or more non-transitory, processor-readable storage devices 725, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable and/or the like. Such storage devices may be configured to implement any appropriate data stores, including, without limitation, various file systems, database structures, and/or the like.

The computer system 700 can also include a communications subsystem 730, which can include, without limitation, a modem, a network card (wireless or wired), an infrared communication device, a wireless communication device, and/or a chipset (such as a Bluetooth™ device, an 802.11 device, a WiFi device, a WiMax device, cellular communication device, etc.), and/or the like. As described herein, the communications subsystem 730 also implemented one or more WLFs 132. For example, the WLF 132 includes UWB transceiver components, WiFi transceiver components, and/or any other suitable components for interfacing with WLAs 142 to implement features described herein. The communications subsystem 730 can also permit data to be exchanged with a network, other computer systems, and/or any other devices described herein. As illustrated, embodiments of the communications subsystem 730 implement the client-side network interface 138 for communicating with at least the BPE communication network 150 (e.g., as described with reference to FIG. 1).

In many embodiments, the computer system 700 further comprises a working memory 735, which can include a RAM or ROM device, as described above. The computer system 700 also can comprise software elements, shown as currently being located within the working memory 735, including an operating system 740, device drivers, executable libraries, and/or other code, such as one or more application programs 745, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general-purpose computer (or other device) to perform one or more operations in accordance with the described methods. As illustrated, the application programs 745 can include (or the working memory 735 can be otherwise programmed to implement) the mapper FE 134 and/or the scheduler FE 136.

A set of these instructions and/or codes might be stored on a non-transitory computer-readable storage medium, such as the non-transitory storage device(s) 725 described above. In some cases, the storage medium might be incorporated within a computer system, such as computer system 700. In other embodiments, the storage medium might be separate from a computer system (e.g., a removable medium, such as a compact disc), and/or provided in an installation package, such that the storage medium can be used to program, configure, and/or adapt a general-purpose computer with the instructions/code stored thereon. These instructions might take the form of executable code, which is executable by the computer system 700 and/or might take the form of source and/or installable code, which, upon compilation and/or installation on the computer system 700 (e.g., using any of a variety of generally available compilers, installation programs, compression/decompression utilities, etc.), then takes the form of executable code.

With regard to both FIGS. 6 and 7, it will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices, such as network input/output devices, may be employed.

As mentioned above, in one aspect, some embodiments may employ a computer system (such as the computer system 600, 700) to perform methods in accordance with various embodiments of the invention. According to a set of embodiments, some or all of the procedures of such methods are performed by the computer system 600, 700 in response to processor(s) 610, 710 executing one or more sequences of one or more instructions (which might be incorporated into the operating system 640, 740 and/or other code, such as an application program 645, 745) contained in the working memory 635, 735. Such instructions may be read into the working memory 635, 735 from another computer-readable medium, such as one or more of the non-transitory storage device(s) 625, 725. Merely by way of example, execution of the sequences of instructions contained in the working memory 635, 735 might cause the processor(s) 610, 710 to perform one or more procedures of the methods described herein.

The terms “machine-readable medium,” “computer-readable storage medium” and “computer-readable medium,” as used herein, refer to any medium that participates in providing data that causes a machine to operate in a specific fashion. These mediums may be non-transitory. In an embodiment implemented using the computer system 600, 700, various computer-readable media might be involved in providing instructions/code to processor(s) 610, 710 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the non-transitory storage device(s) 625, 725. Volatile media include, without limitation, dynamic memory, such as the working memory 635, 735.

Common forms of physical and/or tangible computer-readable media include, for example, a floppy disk, a flexible disk, hard disk, magnetic tape, or any other magnetic medium, a CD-ROM, any other optical medium, any other physical medium with patterns of marks, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 610, 710 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 600, 700.

The communications subsystem 630, 730 (and/or components thereof) generally will receive signals, and the bus 605, 705 then might carry the signals (and/or the data, instructions, etc., carried by the signals) to the working memory 635, 735, from which the processor(s) 610, 710 retrieves and executes the instructions. The instructions received by the working memory 635, 735 may optionally be stored on a non-transitory storage device 625, 725 either before or after execution by the processor(s) 610, 710.

It should further be understood that the components of computer system 600, 700 can be distributed across a network. For example, some processing may be performed in one location using a first processor while other processing may be performed by another processor remote from the first processor. Other components of computer system 600, 700 may be similarly distributed. As such, computer system 600, 700 may be interpreted as a distributed computing system that performs processing in multiple locations. In some instances, computer system 600, 700 may be interpreted as a single computing device, such as a distinct laptop, desktop computer, or the like, depending on the context. In some embodiments, computer system 600 implements a back-end CE 110 using one or more server computers, and computer system 700 implements a client CE 130 using one or more mobile personal computing devices (e.g., a laptop, smartphone, etc.).

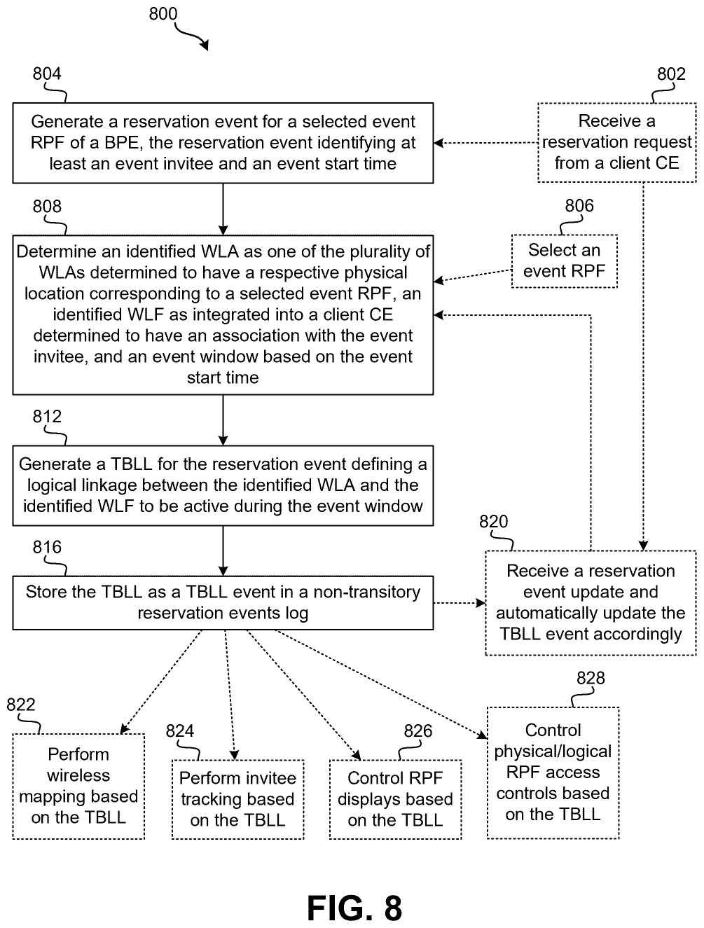

FIG. 8 shows a flow diagram of a method 800 for scheduling reservable physical facilities (RPFs) based on time-bound logical linkages (TBLLs) between wireless location anchors (WLAs) and wireless location finders (WLFs) in a built physical environment (BPE), according to embodiments described herein. The context of the method 800 assumes that the back-end CE is communicatively coupled with a BPE communication network, and that the BPE communication network is further in communication with multiple WLAs. As described herein, each WLA has a respective physical location in the BPE and a respective logical location in the BPE communication network, such that each RPF is physically locatable based on the respective physical location of at least one of the WLAs. Embodiments of the method 800 can be performed using any suitable system, such as those described with reference to FIGS. 1 and 6.

Embodiments of the method 800 begin at stage 804 by generating (e.g., in a back-end CE), a reservation event for a selected event RPF of the BPE. The reservation event identifies at least an event invitee and an event start time. In some cases, for example, the reservation event further identifies an event end time for the reservation event, a selected event RPF, desired or required resources for selecting the event RPF (e.g., A/V equipment needed for a meeting, an EV charger for a parking space, etc.), desired or required access controls to have at the event RPF, etc. In some embodiments, the method begins at stage 802 (prior to stage 804) by receiving a reservation request from one of a number of client CEs (e.g., the client CE associated with the event invitee, another client CE associated with another event invitee, another client CE associated with an inviter that is not one of the invitees, etc.). In such cases, the reservation request can identify at least the event invitee and the event start time (e.g., and additional information, such as an event end time for the reservation event, a selected event RPF, desired or required resources for selecting the event RPF, desired or required access controls to have at the event RPF, etc.).

At stage 808, embodiments can determine (e.g., by the back-end CE) an identified WLA as one of the plurality of WLAs determined to have a respective physical location corresponding to a selected event RPF, an identified WLF as integrated into a client CE determined to have an association with the event invitee, and an event window based on the event start time (e.g., and on an event time if designated). In some embodiments, At stage 806, the event RPF can also be selected. As described herein, some embodiments receive an explicit indication of the event RPF from a client CE as part of receiving the reservation request at stage 802. In other embodiments, the event is selected at stage 806 automatically (e.g., by the back-end CE) by attempting to find an event RPF that matches (e.g., or best matches) characteristics of the reservation event. For example, the reservation request and/or reservation event indicates one or more event characteristics, such as number of attendees for a meeting, type of vehicle for a parking space, whether invitees have or need certain authorization, etc.; and each RPF of the BPE has respective resource characteristics, which can be stored in a RPF resource data store, such as meeting room capacity, available in-room resources, parking space size, reservation price, etc. At stage 806, embodiments can select the event RPF as one having associated resource characteristics that fit well (or best) with the event characteristics.

At stage 812, embodiments can generate a TBLL (e.g., by the back-end CE) for the reservation event. As described herein, the TBLL defines a logical linkage between the identified WLA and the identified WLF to be active during the event window. For example, the linkage is only valid during the event window and is not valid otherwise. In some embodiments, the selection of the event RPF at stage 806 is part of the determining at stage 808; in other embodiments, the selection of the event RPF at stage 806 is part of the generating at stage 812. At stage 816, embodiments can store the TBLL as a TBLL event in a non-transitory reservation events log. In some cases, multiple TBLLs are generated for a single reservation event in stage 812, and those multiple TBLLs are stored as one or more TBLL events in the reservation events log. In some embodiments, subsequent to generating the TBLL entries at stage 816, the method 800 can receive an update to the reservation event at stage 820 (e.g., from a client CE). For example, the update can indicate a change in event attendance, or another change in event characteristics. Further at stage 820, responsive to and in accordance with the reservation event update, the embodiments can automatically update the TBLL event(s) for the reservation event, as needed.

As described herein, the TBLL-based RPF reservation supports various features to be performed based on the TBLL entries. Some embodiments, at stage 822, can interface (e.g., by the back-end CE) with the client CE to automatically perform wireless mapping of the identified WLF to the respective physical location of the identified WLA during the event window based on the TBLL event. For example, the wireless mapping is based on monitoring signal strength measurements between the identified WLF and one or more of the WLAs, such as using UWB transceivers or WiFi transceivers. Some embodiments, at stage 824, can monitor (e.g., by the back-end CE) whether the event invitee is presently located at the event RPF during the event window based on tracking relative physical locations of the identified WLF and the identified WLA during the event window based on the one or more TBLL events. For example, such event attendee tracking can be used to automatically track attendance. Some embodiments, at stage 826, can automatically control (e.g., by the back-end CE) one or more physical displays associated with the event RPF during the event window to display information relating to the reservation event, the event invitee, and/or the event RPF based on the TBLL event. Some embodiments, at stage 828, can automatically control (e.g., by the back-end CE) one or more physical access controls of the event RPF during the event window based on the TBLL event to grant the event invitee with physical access to the event RPF and/or to a physical resource of the event RPF during the event window. Other embodiments, at stage 828, can automatically control (e.g., by the back-end CE) one or more logical access controls of the event RPF during the event window based on the TBLL event to grant the event invitee with logical access to a computational resource, a communication resource, and/or an audiovisual resource of the event RPF during the event window.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. Components of a larger system, wherein other rules may take precedence over or otherwise modify the application of the invention. Also, a number of steps may be undertaken before, during, or after the above elements are considered.

What is claimed is:

1. A system for scheduling reservable physical facilities (RPFs) based on time-bound logical linkages (TBLLs) between wireless location anchors (WLAs) and wireless location finders (WLFs) in a built physical environment (BPE), the system comprising:
a back-end computational environment (CE) comprising:
a back-end network interface to communicatively couple with a BPE communication network, wherein the BPE communication network is further in communication with a plurality of WLAs, each having a respective physical location in the BPE and a respective logical location in the BPE communication network, wherein each RPF is physically locatable based on the respective physical location of at least one of the WLAs;
a scheduler back-end to generate a reservation event for a selected event RPF of the BPE, the reservation event identifying at least an event invitee and an event start time;
a non-transitory processor-readable reservation events log; and
a TBLL engine to:
generate one or more TBLLs based on the reservation event, each TBLL defining a logical linkage between an identified WLA and an identified WLF to be active during an event window, wherein the identified WLA is one of the plurality of WLAs determined to have a respective physical location corresponding to the selected event RPF, the identified WLF integrated into a client CE determined to have an association with the event invitee, and the event window determined based on the event start time; and
store the one or more TBLLs as one or more TBLL events in the reservation events log.

2. The system of claim 1, wherein:
the scheduler back-end is further to receive a reservation event update and to notify the TBLL engine of the reservation event update; and
the TBLL engine is further to automatically update the one or more TBLL events in response to and in accordance with the reservation event update.

3. The system of claim 1, wherein the back-end CE further comprises:
a mapper back-end to interface with a mapper front-end running in the client CE to automatically perform wireless mapping of the identified WLF to the respective physical location of the identified WLA during the event window based on the one or more TBLL events, the wireless mapping based on monitoring signal strength measurements between the identified WLF and one or more of the WLAs.

4. The system of claim 1, wherein the back-end CE further comprises:
a BPE infrastructure back-end to automatically control one or more physical displays associated with the event RPF during the event window to display information relating to the reservation event, the event invitee, and/or the event RPF based on the one or more TBLL events.

5. The system of claim 1, wherein the back-end CE further comprises:
a BPE infrastructure back-end to grant the event invitee with physical access to the event RPF and/or to a physical resource of the event RPF during the event window by automatically controlling one or more physical access controls of the event RPF during the event window based on the one or more TBLL events.

6. The system of claim 1, wherein the back-end CE further comprises:
a BPE infrastructure back-end to grant the event invitee with logical access to a computational resource, a communication resource, and/or an audiovisual resource of the event RPF during the event window by automatically controlling one or more logical access controls of the event RPF during the event window based on the one or more TBLL events.

7. The system of claim 1, wherein the back-end CE further comprises:
a tracker back-end to monitor whether the event invitee is presently located at the event RPF during the event window based on tracking relative physical locations of the identified WLF and the identified WLA during the event window based on the one or more TBLL events.

8. The system of claim 1, wherein:
the client CE is one of a plurality of client CEs; and
the scheduler back-end is further to receive a reservation request from a scheduler front-end running on one of the plurality of client CEs, the reservation request identifying at least the event invitee and the event start time, and to generate the reservation event responsive to and in accordance with receiving the reservation request.

9. The system of claim 1, further comprising:
a non-transitory RPF resource data store indicating a list of the RPFs of the BPE, each RPF stored in association with the respective physical location and respective resource characteristics,
wherein the reservation event indicates one or more event characteristics including a number of event invitees, the event invitee being one of the number of event invitees, and
wherein the scheduler back-end is further to automatically select the event RPF from the list of RPFs in the RPF resource data store so that the respective resource characteristics of the event RPF satisfy the event characteristics indicated by the reservation request.

10. The system of claim 1, further comprising:
the BPE communication network.

11. The system of claim 1, further comprising:
the plurality of WLAs.

12. A method for scheduling reservable physical facilities (RPFs) based on time-bound logical linkages (TBLLs) between wireless location anchors (WLAs) and wireless location finders (WLFs) in a built physical environment (BPE), the method comprising:
generating, in a back-end computational environment (CE), a reservation event for a selected event RPF of the BPE, the reservation event identifying at least an event invitee and an event start time,
wherein the back-end CE is communicatively coupled with a BPE communication network, and the BPE communication network is further in communication with a plurality of WLAs, each having a respective physical location in the BPE and a respective logical location in the BPE communication network, wherein each RPF is physically locatable based on the respective physical location of at least one of the WLAs;
determining, by the back-end CE, an identified WLA as one of the plurality of WLAs determined to have a respective physical location corresponding to a selected event RPF, an identified WLF as integrated into a client CE determined to have an association with the event invitee, and an event window based on the event start time;
generating a TBLL by the back-end CE for the reservation event, the TBLL defining a logical linkage between the identified WLA and the identified WLF to be active during the event window; and
storing the TBLL as a TBLL event in a non-transitory reservation events log.

13. The method of claim 12, further comprising:
receiving a reservation event update; and
automatically updating the TBLL event in response to and in accordance with the reservation event update.

14. The method of claim 12, further comprising:
interfacing, by the back-end CE, with the client CE to automatically perform wireless mapping of the identified WLF to the respective physical location of the identified WLA during the event window based on the TBLL event, the wireless mapping based on monitoring signal strength measurements between the identified WLF and one or more of the WLAs.

15. The method of claim 12, further comprising:
automatically controlling, by the back-end CE, one or more physical displays associated with the event RPF during the event window to display information relating to the reservation event, the event invitee, and/or the event RPF based on the TBLL event.

16. The method of claim 12, further comprising:
automatically controlling, by the back-end CE, one or more physical access controls of the event RPF during the event window based on the TBLL event to grant the event invitee with physical access to the event RPF and/or to a physical resource of the event RPF during the event window.

17. The method of claim 12, further comprising:
automatically controlling, by the back-end CE, one or more logical access controls of the event RPF during the event window based on the TBLL event to grant the event invitee with logical access to a computational resource, a communication resource, and/or an audiovisual resource of the event RPF during the event window.

18. The method of claim 12, further comprising:
monitoring, by the back-end CE, whether the event invitee is presently located at the event RPF during the event window based on tracking relative physical locations of the identified WLF and the identified WLA during the event window based on the one or more TBLL events.

19. The method of claim 12, further comprising:
receiving a reservation request from one of a plurality of client CEs including the client CE, the reservation request identifying at least the event invitee and the event start time,
wherein the generating the reservation event is responsive to and in accordance with the receiving the reservation request.

20. The method of claim 12, wherein:
the reservation request indicates one or more event characteristics;
each RPF of the BPE has respective resource characteristics stored in a RPF resource data store; and
the generating the reservation event further comprises automatically selecting the event RPF from the RPF resource data store so that the respective resource characteristics of the event RPF satisfy the event characteristics indicated by the reservation request.
